(19) United States
(12) Patent Application Publication
(10) Pub. No.: US 2014/0162028 A1
(43) Pub. Date: Jun. 12, 2014

(54) PLANAR CARRIER AND A METHOD FOR PRODUCING A PLANAR CARRIER

(71) Applicants: Georg Aigner, Pabneukirchen (AT); Johann Hilburger, Pirk (DE)

(72) Inventors: Georg Aigner, Pabneukirchen (AT); Johann Hilburger, Pirk (DE)

(73) Assignee: HUECK FOLIEN GESELLSCHAFT m.b.H., Baumgartenberg (AT)

(21) Appl. No.: 14/232,675

(22) PCT Filed: Jul. 13, 2012
(86) PCT No.: PCT/AT2012/050104

§ 371 Date: Jan. 24, 2014

(30) Foreign Application Priority Data
Jul. 15, 2011 (AT) A 1042/2011

(51) Int. Cl. B32B 3/26; B32B 37/24

(52) U.S. Cl. CPC B32B 3/263; B32B 37/24
USPC 428/172; 156/246

(57) ABSTRACT

A planar carrier, in particular a decorative strip, for applying to an object, having a polymeric carrier layer and a polymeric coating layer which is connected to the carrier layer and which has a surface at least partially imprinted by means of a reverse coating in particular on release paper. In order to provide advantageous construction conditions, the carrier layer, which takes the form of a carrier film, has a higher elastic property than the coating layer which consists of a radiation-curable duroplastic polymer, in particular UV coating, in order to at least partially reduce mechanical stresses.

### TECHNICAL FIELD

The invention relates to a method for the production of a planar carrier and to a planar carrier and, in particular, a decorative strip, for application to an object, having a polymer carrier layer and a polymer coating layer connected with the carrier layer, which has a surface at least partially embossed using reverse coating, particularly on release paper.

### STATE OF THE ART

From the state of the art (DE 102008 034479), material strips are known that consist of a coating layer, which are provided with a cross-linking material, particularly of a polyurethane material or, additionally, also with a nonwoven fabric. For this purpose, the coating used and the cross-linking material are cured by the introduction of heat, by way of heating devices. Furthermore, a ventilation device is provided to further accelerate curing or drying of the coating layer, and to capture the vapors that develop over the course of curing, so as to protect the environment. Furthermore, the coating layer has an embossed surface created by means of reverse coating on release paper. It is disadvantageous, among other things, that material strips or planar carriers produced in this manner can be produced only from very specific coatings—particularly heat-curable coatings—or cross-linking materials. Furthermore, cross-linking materials applied to a coating layer—particularly polyurethane—are also disadvantageous with regard to their mechanical properties, and for this reason, a nonwoven fabric must be applied to the polyurethane layer in the state of the art, in a further method step. Furthermore, this production method is comparatively subject to errors, because the degrees of curing of coating and cross-linking material must be strictly adhered to—for example in order to be able to guarantee the production of a coating layer of constant thickness. A robust decorative strip for application to an object and a simple method for the production of such a decorative strip cannot be made possible in this manner.

### PRESENTATION OF THE INVENTION

The invention has therefore set itself the task of improving a planar carrier of the type described initially, in such a manner that it is particularly resistant particularly to chemical and/or mechanical stresses, but nevertheless can be connected firmly with an object or a substratum, in order to protect and/or optically refine the latter.

The invention accomplishes the stated task in that the carrier layer, configured as a carrier film, demonstrates a greater elastic property as compared with the coating layer consisting of a radiation-curable duroplastic polymer, particularly UV coating, for at least partial reduction of mechanical stresses.

If the carrier layer configured as a carrier film has a greater elastic property as compared with the coating layer consisting of a radiation-curable duroplastic polymer, then this elastic property can be utilized to keep possible mechanical stresses away from the comparatively hard polymer coating layer, so that the latter can be uncoupled from them and thereby protected. The planar carrier according to the invention or the decorative strip or the decorative film/foil can therefore make it possible, in contrast to the state of the art, that a coating layer consisting of a radiation-curable duroplastic polymer, which does not change its shape after curing, or only changes shape to an extremely slight extent, or does not react to mechanical influences, particularly stresses, for example with the formation of cracks or gaps, or only reacts to a slight extent, can be connected with any object or substratum whatsoever, without reservations. Flexible application possibilities of such a carrier can thereby be opened up—for example bendable check cards all the way to rigid furniture surfaces are possible. Nevertheless, the planar carrier makes great resistance possible by means of its special coating layer, particularly with regard to chemical and/or mechanical stresses such as scratch resistance, for example—so that the object or substratum provided with it can be better protected. A UV coating has proven to be preferable as such a protective layer, whereby a radically curable UV coating can be particularly suitable for this purpose. UV coating has proven to be advantageous particularly because curing of UV coatings can be particularly easily controlled by means of targeted irradiation—and, in particular can also take place very rapidly—and also cures with a better surface quality. Furthermore, UV coatings are not only particularly environmentally friendly because of their freedom from solvents, but they are also non-problematic with regard to health aspects. The invention can therefore allow a particularly robust and easily processed planar carrier that can be universally attached to different objects or substrata, in robust manner.

A particularly robust planar carrier can be produced if the coating layer is based on acryl, alkyl, epoxy, polyester, or polyurethane. In this way, specifically, improved cross-linking of the coating and therefore a particularly strong coating layer can be made possible.

If the coating layer is connected with the carrier film by way of a lamination adhesive, with material fit, a particularly good connection can be produced in simple manner, which can guarantee a robust connection even at greater mechanical stress, because of the permanent flexibility of the lamination adhesive. Furthermore, a lamination adhesive can offer by means of the advantage of optical transparency and thereby slight optical perception.

If the coating layer follows the carrier film with material fit, not only can a carrier having a particularly simple design be created, but also, optical impairments can be kept comparatively slight in this manner.

If the coating layer forms a surface of the planar carrier with its embossed surface, the perception of the embossing can take place not only optically but also, advantageously, it can be felt or perceived haptically.

If the coating layer is laminated against a cover film with its embossed surface, it is true that haptic perception of the embossing can no longer be guaranteed, but the planar carrier can nevertheless create an optical perception of the embossing. If the depth of the embossing of the coating layer lies in a range of up to several hundred micrometers, for example, a three-dimensional effect can particularly be created if the boundary surface between an embossed coating layer and a further layer, for example a metallic layer or a further coating layer, is viewed through it. Furthermore, in this way, the possibility of providing functional elements between cover film and coating layer can be opened up. A carrier that can be used in particularly variable and flexible manner can be created in this manner.

In order to allow improved perception of the embossing of the coating layer, the coating layer can have a layer composed of a metal, a metal alloy or a metal compound on its embossed surface and/or on its non-embossed surface, at least in part.

Simple connection possibilities with an object or a substratum can result if a self-adhesive, hot-sealing or cold-sealing coating applied on the side of the carrier film facing away from the coating layer

If effect pigments are provided, at least in certain regions, between the coating layer and the carrier film, optical properties, such as angle-dependent color tone and gloss changes or textures, for example, can be made possible, among other things. The carrier film can therefore advantageously find use in numerous application areas. Thus, it is possible, for example, to also produce holograms using the planar carrier according to the invention.

The invention has furthermore set itself the task of improving a method for the production of a planar carrier of the type stated initially, in such a manner that this can be implemented in simple, robust, and environmentally friendly manner.

The invention accomplishes the stated task in that a coating layer consisting of a radiation-curable duroplastic polymer is applied to the release paper and subjected to complete curing using UV radiation or electron radiation, and after curing, the coating layer is connected with a carrier layer configured as a carrier film.

If a coating layer consisting of a radiation-curable duroplastic polymer is applied to the release paper and subjected to complete curing using UV radiation or electron radiation, then among other things, it can be ensured that a particularly robust planar carrier is created. Furthermore, impairments with regard to the optical properties can also be reduced if such a coating layer is processed further. This is because the coating layer is only connected with a carrier layer configured as a carrier film after it has cured, so that it can be prevented that chemical and/or mechanical process parameters that occur during the course of curing of the coating layer or of connecting the coating layer with the carrier film will reciprocally influence one another. The method according to the invention can therefore create a particularly robust planar carrier, with tight process parameters, in robustly reproducible manner. In addition, if desired, processing of the side of the coating layer that faces the carrier layer can also take place, for example in order to color it. Furthermore, the carrier film can be configured in such a manner that the planar carrier can be processed further without the carrier layer having to be connected with an additional further layer or such a further layer being required. Furthermore, a coating layer consisting of a radiation-curable duroplastic polymer, particularly a UV coating layer, can allow particularly environmentally friendly production conditions, among other things because they can be free of solvents or because no provision of heat is required for curing. Therefore, a method that is not only simple and robust but also protects the environment can be made possible.

If the embossed coating layer is coated, on the rear, non-embossed surface, at least in part, with a metal, a metal alloy or a metal compound, then a special release separating layer between the coating layer and the further rear structure of the planar carrier can be created in this way, thereby bringing about the possibility of achieving additional optical effects of the planar carrier—for example metallic gleam of the planar carrier. A primer (adhesion promoter) can be applied to the coating layer, in advantageous manner, before this coating process of the coating layer takes place.

If the coating layer is laminated or laminated against a cover film with its embossed side, an optical impression of depth can be achieved and/or maintained. Furthermore, processing of a comparatively hard coating layer on its embossed side can be facilitated by smoothing of the embossing.

For simple handling conditions of the planar carrier, for example in order to connect the carrier with a substrate or an object, the method can also provide that a self-adhesive, hot-sealing or cold-sealing coating is applied to the planar carrier.

Furthermore, it should be mentioned that plastic films, for example composed of PI, 35 PP, MOPP, PE, PPS, PEEK, PEE, PEI, PSU, PAEK, LCP, PEN, PET, PET, PA, PMMA, PC, COC, POM, ABS, PVC are possible as polymer carrier films, for example. For application of a UV coating to an embossed decorative paper, intaglio printing, screen printing, flexographic printing, digital printing, Curtain Coating and the like are possible. Possible metallic coatings are Al, Cu, Ag, Au, Ni, Cr, Pt, Pd, Sn, Zn, Co, Fe, In, for example. Furthermore, alloys, metal mixtures or metal compounds, such as oxides, chromates or sulfides, can also be applied as a metallic coating. Cu/Al or Al/Cr alloys, or metal compounds, particularly TiO2, Cr oxides, ZnS, ITO, bi-oxide, ATO, FTO, ZnO, Al2O3, Zn chromate, Fe oxides, CuO, and the like, for example, are suitable. The metallic coating can be applied, for example, by means of a PVD or CVD method, but application from a liquid medium is also possible. Furthermore, the metallic coating can be applied by means of lamination with a metal foil, for example by means of hot lamination or IR-supported, using homologous adhesives. To increase the mechanical resistance, for example the friction wear resistance, the shear strength and elongation resistance, the rolling strength, and the like, elastomer modifiers, for example elastomer polymers and copolymers, such as EPR or nanoparticles, and the like, can preferably be added.

By means of the robust configuration, according to the invention, of the planar carrier, the latter can be particularly suitable as a decorative label, a security label, or a decorative film/foil for furniture surfaces, metal parts or plastic parts.

### BRIEF DESCRIPTION OF THE DRAWING

In the figures, the object of the invention is shown as an example, using multiple exemplary embodiments. The drawing shows:

FIG. 1 a sectional view through a planar carrier.

FIG. 2 an alternative embodiment of the planar carrier shown in FIG. 1,

FIG. 3 a further exemplary embodiment of a planar carrier, and

FIG. 4 a representation of a production method of the planar carrier according to FIG. 1.

### WAY TO IMPLEMENT THE INVENTION

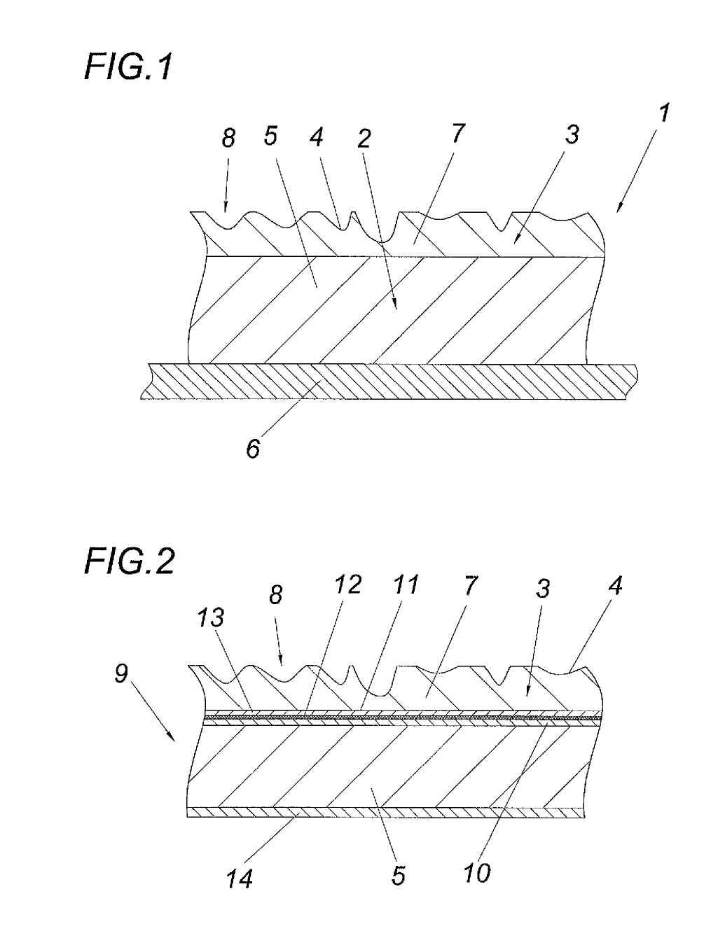

The planar carrier 1 shown according to FIG. 1 has a polymer carrier layer 2 and a polymer coating layer 3 connected with the carrier layer 2. Embossing of an embossed surface 4 was introduced into this coating layer 3; this is achieved using reverse coating on release paper 20 as known from reversing methods. Because a radiation-curable duroplastic polymer was used for the coating layer 3, according to the invention, it is true that the coating layer is comparatively hard, but it is comparatively sensitive to mechanical stresses—above all, it is brittle. For this purpose, a carrier layer 2 configured as a carrier film 5 is now used, which has a greater elastic property as compared with the coating layer 3. For this reason, mechanical stresses, for example caused by thermally related movements of an object 6 connected with the planar carrier 1, can at least be absorbed and dissipated by the carrier film 5. In this way, the coating layer 3 can advantageously be protected, thereby making it possible to create a robust planar carrier 1. As compared with the state of the art, a particularly robust planar carrier 1 or decorative film/foil can thereby be created, in simple manner, in terms of design, which not only protects the object 6 but also can guarantee a robust connection with this object 6. Excellent robustness can result from the use of a UV coating 7 as the coating layer 3. Coating layers 3 based on acryl, alkyl, epoxy, polyester or polyurethane are furthermore possible. In this exemplary embodiment according to FIG. 1, coating layer 3 and carrier film 5 are connected with one another with material fit, thereby making it possible to create simple design conditions.

As can furthermore be seen in FIG. 1, the coating layer 3 with its embossed surface 4 forms the surface 8 of the planar carrier. The relief of the embossed surface 4 can therefore be felt haptically.

Furthermore, according to FIG. 2, it can be seen, in an embodiment of a planar carrier 9, that a metal layer 12 is provided on the non-embossed surface 11 of the coating layer 3 or on its surface 11 that lies opposite the embossed surface 4. However, effect pigments can also be provided between the coating layer 3 and the carrier film 5, which have not been shown in any detail here.

In advantageous manner for adhesion purposes, a primer 13 can also be provided between the metal layer 12 and the coating layer 3, and a lamination adhesive 10 can be provided between the metal layer 12 and the carrier film 5.

Furthermore, for simple installation purposes, a self-adhesive coating 14 is applied on the side of the carrier film 5 that faces away from the coating layer 3.

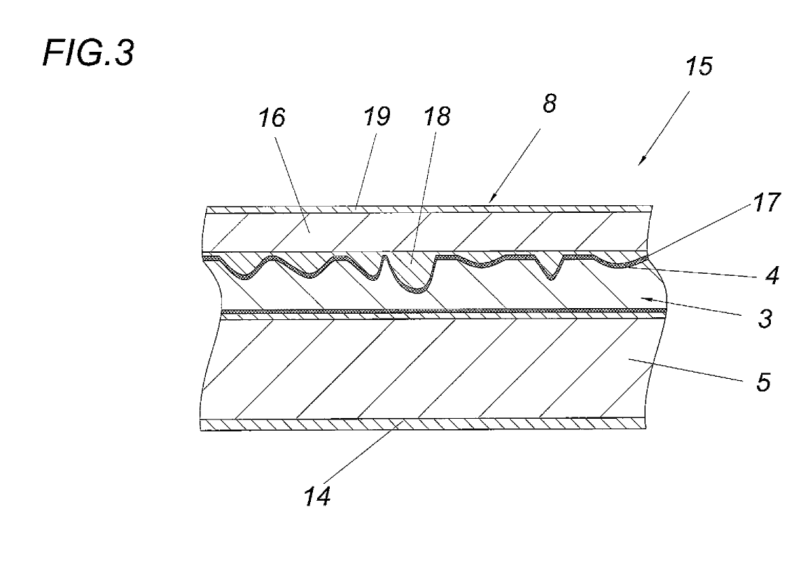

According to FIG. 3, a further embodiment of a planar carrier 15 is shown. Here, the coating layer 3 is laminated or laminated against a cover film 16 with its embossed surface 4. Likewise, a further metallization 17, which forms a composite with the cover film 16 by way of a lamination adhesive 18, can be provided on the embossed side 4 of the coating layer 3. For improved further processing purposes, particularly for possible imprinting of the planar carrier 1, a printing primer 19, which also allows a smooth surface of the planar carrier 1, among other things, is furthermore provided on the cover film 16. The structure below the coating layer 3 can be the same as the structure shown in FIG. 2, whereby it is also possible to do without a lamination adhesive 10 as shown in FIG. 2.

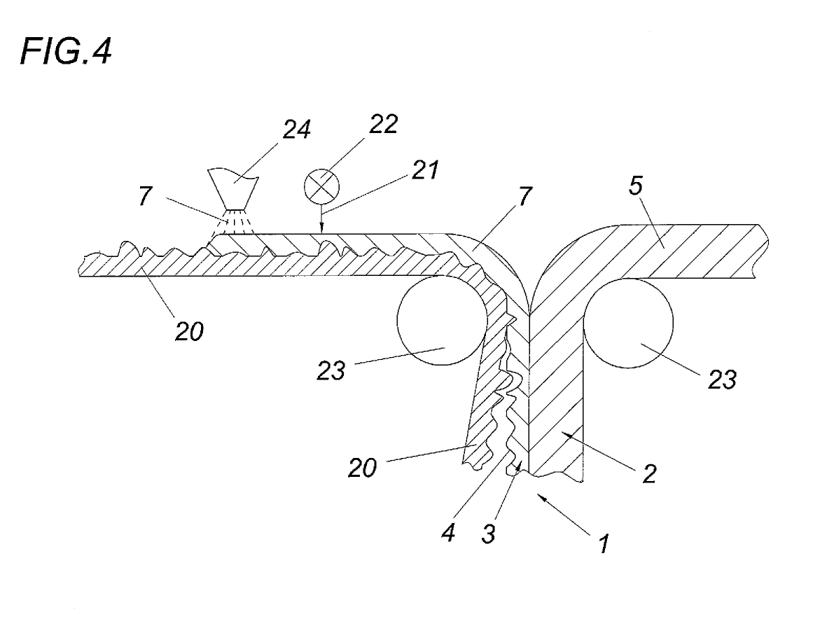

According to FIG. 4, a method for the production of the planar carrier 1 according to FIG. 1 is shown as an example. In order to create an embossed surface 4 on the planar carrier 1, a release paper 20 known from reversing methods or transfer coatings is used. The surface of the release paper 20 therefore serves as a negative for the grain or negative grain of the embossed surface 4. A polymer coating layer 3 is applied to the full area of the embossed release paper 20, in that a nozzle 24 sprays liquid UV coating 7 onto the release paper 20. The coating 7 is then completely cured using UV radiation 21 of a lamp 22. After this curing, the coating layer 3 is connected with a carrier layer 2 configured as a carrier film 5, in that release paper 20, coating layer 3, and carrier film 5 are passed through rollers 23 that are braced relative to one another. The connection between coating layer 3 and carrier film 5 can also be produced, for example, by means of the use of a lamination adhesive, which is not shown in any detail here. After the firm and/or material-fit connection between coating layer 3 and carrier film 5 has been produced, the release paper 20 is removed, at some point. This removal of the release paper 20 can also take place during the course of a reversing process in which the planar carrier 1 is used, in order to perform an application process, for example.

A comparatively scratch-resistant coating by means of a coating layer 3 composed of a radiation-curable duroplastic polymer can thereby be robustly connected with a carrier film 5, which planar carrier 1 can furthermore be characterized by an embossed surface 4.

1. Planar carrier, in particular, a decorative strip, for application to an object (6), having a polymer carrier layer (2) and a polymer coating layer (3) connected with the carrier layer (2), which has a surface (4) at least partially embossed using reverse coating, particularly on release paper (20), wherein the carrier layer (2), configured as a carrier film (5), demonstrates a greater elastic property as compared with the coating layer (3) consisting of a radiation-curable duroplastic polymer, particularly UV coating (7), for at least partial reduction of mechanical stresses.

2. Planar carrier according to claim 1, wherein the coating layer (3) is based on acryl, alkyl, epoxy, polyester or polyurethane.

3. Planar carrier according to claim 1, wherein the coating layer (3) is connected with the carrier film (5) with material fit, by way of a lamination adhesive (10).

4. Planar carrier according to claim 1, wherein the coating layer (3) follows the carrier film (5) with material fit.

5. Planar carrier according to claim 1, in a wherein the coating layer (3) forms a surface (8) of the planar carrier (1, 9) with its embossed surface (4).

6. Planar carrier according to claim 1, wherein the coating layer (3) is laminated against a cover film (16) with its embossed surface (4).

7. Planar carrier according to claim 1, wherein the coating layer (3) has a layer (12) composed of a metal, a metal alloy or a metal compound on its embossed surface (4) and/or its non-embossed surface (11), at least in part.

8. Planar carrier according to claim 1, wherein a self-adhesive, hot-sealing or cold-sealing coating (14) is applied to the side of the carrier film (5) that faces away from the coating layer (3).

9. Planar carrier according to claim 1, wherein effect pigments are provided between the coating layer (3) and the carrier film (5), at least in certain regions.

10. Method for the production of a planar carrier (1, 9, 15), in particular, a decorative strip, according to claim 1, in which a polymer coating layer (3) is applied to an embossed release paper (20), over the full area or partially, and cured, the thereby embossed coating layer (3) is connected with a carrier layer (2), and the release paper is at some point pulled off the planar carrier (1, 9, 15), wherein a coating layer (3) consisting of a radiation-curable duroplastic polymer is applied to the release paper (20) and subjected to complete curing using UV radiation or electron radiation, and wherein the coating layer (3) is connected with a carrier layer (2) configured as a carrier film (5) after it has cured.

11. Method according to claim 10, wherein the embossed coating layer (3) is coated with a metal, a metal alloy or a metal compound, at least in part, on the rear, non-embossed surface (11).

12. Method according to claim 10, wherein the coating layer (3) is laminated against a cover film (16) with its embossed surface (4).

13. Method according to claim 10, wherein a self-adhesive, hot-sealing or cold-sealing coating (14) is applied to the planar carrier (9, 15).

14. Use of a planar carrier (1, 9, 15) according to claim 1 as a decorative label, security label or decorative film/foil for furniture surfaces, metal parts or plastic parts.
